(19) United States
(12) Patent Application Publication
(10) Pub. No.: US 2002/0010605 A1
(43) Pub. Date: Jan. 24, 2002

(54) Casualness without cot

(76) Inventors: Sergey Dorofeev, Melbourne (AU); Peter Grant, Melbourne (AU); Gary C. Morgan, Melbourne (AU)

Correspondence Address: Max Stul Oppenheimer, P.O. Box 50, Stevenson, MD, 21153, US

(21) Appl. No.: 09/833,220

(22) Filed: Apr. 11, 2001

Related U.S. Application Data
(60) Provisional application No. 60/196,880, filed on Apr. 12, 2000.

(51) Int. Cl. G06F 17/60

(52) U.S. Cl. 705/7

(57) ABSTRACT

The first two paragaphs of Attached Document 1 is incorporated herein as the Abstract of the disclosure.

This application is entitled to and claims the benefit of U.S. Provisional Patent Application No. 60/196,880 filed Apr. 12, 2000, the contents of which are incorporated herein by reference.

The attached documents are incorporated herein by reference:

1. Jun. 18, 1999 Memorandum from Sergey Dorofeev to Gary Morgan, et al, Re: Casualness without COT

2. Morgan Media Poll (marked “old”)

3. Morgan Media Poll (marked “new”)

The first two paragaphs of Attached Document 1 is incorporated herein as the Abstract of the disclosure.

The drawings and illustrations of the Attached Documents are incorporated herein as the Drawings of the disclosure.

### FIELD AND BACKGROUND OF THE INVENTION

1. Field of the Invention

The present invention relates in general to data analysis, and more particularly to analysis of data relating to consumer, viewership, readership and circulation surveys.

Background Information

Background Information is presented in the Attached Documents.

### SUMMARY OF THE INVENTION

The invention, its objects, features and advantages are summarized in the Attached Documents.

### DESCRIPTION OF THE PREFERRED EMBODIMENT

The currently envisioned preferred embodiment is set forth in the Attached Documents.

What is claimed is:

1. A method for computing casualness for magazines comprising the steps of:
obtaining a diary of information comprising questions based on recency and frequency;
wherein questions relating to frequency are directed to two, and only two, time periods; and
computing casualness based on the diary of information.
